(19) United States
(12) Patent Application Publication
(10) Pub. No.: US 2019/0018103 A1
(43) Pub. Date: Jan. 17, 2019

(54) STORAGE MEDIUM, UNMANNED AERIAL VEHICLE AND METHOD AND SYSTEM FOR VIBRATION DETECTION AND TRACKING CONTROL

(71) Applicant: SZ DJI Technology Co., Ltd, Shenzhen (CN)

(72) Inventors: Jie Qian, Shenzhen (CN); Bo Zang, Shenzhen (CN); Cong Zhao, Shenzhen (CN)

(21) Appl. No.: 16/119,765

(22) Filed: Aug. 31, 2018

Related U.S. Application Data
(63) Continuation of application No. PCT/CN2016/075156, filed on Mar. 1, 2016.

(51) Int. Cl. G01S 5/06; B64C 39/02

(52) U.S. Cl. CPC G01S 5/06; G05D 1/0044; B64C 39/024

(57) ABSTRACT

A method for tracking control of an unmanned aerial vehicle (UAV) includes obtaining flight data of the UAV, determining, within a preset period of time and according to the flight data, a number of switching times of the UAV switching between different flight directions, determining whether the UAV is vibrating according to the number of switching times, and determining whether to continue tracking a target according to whether the UAV is vibrating.

### CROSS-REFERENCE TO RELATED APPLICATION

This application is a continuation of International Application No. PCT/CN2016/075156, filed on Mar. 1, 2016, the entire contents of which are incorporated herein by reference.

### TECHNICAL FIELD

The present disclosure relates to the field of unmanned aerial vehicles (UAVs), and in particular to a storage medium, a UAV, and a method and a system for vibration detection and tracking control.

### BACKGROUND

With the rapid development of electronic technology and communication technology, more and more aircrafts, robots, etc., are manufactured. In the technical field of aircrafts, the research and development of UAVs are becoming more and more widespread, however flight safety performance of the UAV is of vital importance.

In the flight process of the UAV, due to the effects of air convection, temperature, or other factors, vibration of fuselage is easy to be generated, and a large magnitude of vibration of the UAV will affect the normal operation and the flight of the UAV and even cause a crash of the UAV in severe cases.

Therefore, there is an urgent need for a method for vibration detection of the UAV, to determine whether the UAV has a vibration, and to, before determining that the vibration magnitude of the UAV is large, conduct an adjustment on the conditions of the UAV in time to avoid an impact on the normal operation and flight of the UAV and even the case of a crash.

### SUMMARY

In view of the defects above in the conventional technologies, a method for vibration detection of the UAV is provided in the present disclosure to determine whether the UAV has a vibration, and to, before confirming that the vibration magnitude of the UAV is large, conduct an adjustment on the conditions of the UAV in time to avoid an impact on the normal operation and flight of the UAV and even the case of a crash.

According to a first aspect of the present disclosure, there is provided a method for vibration detection of a UAV, including:

obtaining flight data of the UAV;

determining, within a preset period of time, switching times of the UAV between different flight directions according to the flight data;

determining whether the UAV has a vibration according to the switching times;

determining whether to continue tracking the target according to vibration conditions of the UAV;

according to a second aspect of the present disclosure, there is provided a method for tracking control of a UAV, including:

obtaining flight data of the UAV;

determining, within a preset period of time, switching times of the UAV between different flight directions according to the flight data;

determining whether the UAV has a vibration according to the switching times.

determining whether to continue tracking the target according to vibration conditions of the UAV.

According to a third aspect of the present disclosure, there is provided a system for vibration detection of the UAV, including:

a first obtaining circuit, configured to obtain flight data of the UAV;

a first processing circuit, configured to determine, within a preset period of time, switching times of the UAV between different directions according to the flight data;

a first determining circuit, configured to determine whether the UAV has a vibration according to the switching times.

According to a fourth aspect of the present disclosure, there is provided a system for tracking control of the UAV, including:

a second obtaining circuit, configured to obtain flight data of the UAV;

a second processing circuit, configured to determine, within a preset period of time, switching times of the UAV between different directions according to the flight data;

a second determining circuit, configured to determine whether the UAV has a vibration according to the switching times;

where the second determining circuit is further configured to determine whether to continue tracking the target according to vibration conditions of the UAV.

According to a fifth aspect of the present disclosure, there is provided a UAV including: a fist flight data collecting device and a first processor;

where the first flight data collecting device is configured to obtain flight data of the UAV;

the first processor is configured to perform:

determining within a preset period of time switching times of the UAV between different directions according to the flight data;

determining whether the UAV has a vibration according to the switching times.

According to the sixth aspect of the present disclosure, there is provided a storage medium in which program code is stored, and when the program code is run, a method for vibration detection of a UAV is performed, the method including:

obtaining flight data of the UAV;

determining, within a preset period of time, switching times of the UAV between different directions according to the flight data;

determining whether the UAV has a vibration according to the switching times.

According to a seventh aspect of the present disclosure, there is provided a further UAV, including: a second flight data collecting device and a second processor;

where the second flight data collecting device is configured to obtain flight data of the UAV;

the second processor is configured to perform:

determining, within a preset period of time, switching times of the UAV between different directions according to the flight data;

determining whether the UAV has a vibration according to the switching times;

determining whether to continue tracking the target according to the vibration conditions of the UAV.

According to an eighth aspect of the present disclosure, there is provided a storage medium, in which program code is stored, and when the program code is run, a method for vibration detection of a UAV is performed, the method including:

obtaining flight data of the UAV;

determining, within a preset period of time, switching times of the UAV between different directions according to the flight data;

determining whether the UAV has a vibration according to the switching times;

determining whether to continue tracking the target according to the vibration conditions of the UAV.

The storage medium, the UAV and the method and system for vibration detection and tracking control provided in the present disclosure avoid an impact on normal operation and flight of the UAV and even a case of a crash, thus improve the safety and reliability of the flight of the UAV by determining the switching times of the UAV between different directions in a preset period of time according to the flight data, determining whether the UAV has a vibration according to the switching times, and before determining that the vibration magnitude of the UAV is large, conducting an adjustment on the conditions of the UAV in time.

### BRIEF DESCRIPTION OF DRAWINGS

FIG. 1 is a flow diagram of the method for vibration detection of the UAV provided in the first embodiment of the present disclosure;

FIG. 2 is a flow diagram of the method for vibration detection of the UAV provided in the second embodiment of the present disclosure;

FIG. 3 is a flow diagram of the method for vibration detection of the UAV provided in the third embodiment of the present disclosure;

FIG. 4 is a flow diagram of the method for vibration detection of the UAV provided in the fourth embodiment of the present disclosure;

FIG. 5 is a flow diagram of the method for tracking control of the UAV provided in the first embodiment of the present disclosure;

FIG. 6 is a flow diagram of the method for tracking control of the UAV provided in the second embodiment of the present disclosure;

FIG. 7 is a flow diagram of the method for tracking control of the UAV provided in the third embodiment of the present disclosure;

FIG. 8 is a flow diagram of the method for tracking control of the UAV provided in the fourth embodiment of the present disclosure;

FIG. 9 is a flow diagram of the method for tracking control of the UAV provided in the fifth embodiment of the present disclosure;

FIG. 10 is a schematic structural diagram of the system for vibration detection of the UAV provided in the first embodiment of the present disclosure;

FIG. 11 is a schematic structural diagram of the system for tracking control of the UAV provided in the first embodiment of the present disclosure;

FIG. 12 is a schematic structural diagram of the UAV provided in the first embodiment of the present disclosure;

FIG. 13 is a structural diagram of the UAV provided in the second embodiment of the present disclosure.

### REFERENCE NUMERALS

| | |
|---|---|
| 1 - First obtaining circuit; | 2 - First processing circuit; |
| 3 - First determining circuit; | 4 - Second obtaining circuit; |
| 5 - Second processing circuit; | 6 - Second determining circuit; |
| 7 - First flight data collecting device; | 8 - First processor; |
| 9 - Second flight data collecting device; | 10 - Second processor. |

### DESCRIPTION OF EMBODIMENTS

A number of embodiments are illustrated in detail below with reference to the accompanying drawings. In the case without conflict, the embodiments and the features in the embodiments can be combined with each other.

### The First Embodiment

A method for vibration detection of the UAV is provided in the present embodiment. FIG. 1 is a flow diagram of the method for vibration detection of the UAV provided in the first embodiment of the present disclosure, as shown in FIG. 1, the method for vibration detection of the UAV including:

S11: obtaining the flight data of the UAV;

where, the type of the obtained flight data of the UAV and the obtaining means thereof are not defined and can be set by those skilled in the art according to the specific design requirements. The flight data can be set, for example, as a combination of any one or more of the flight direction, flight path, flight speed, flight acceleration, flight location and flight environment; and based on the different flight data above, those skilled in the art can employ different means of obtaining data, such as using a direction sensor to obtain the information of the flight direction, using a speed sensor or an acceleration sensor to obtain the information of the flight speed or flight acceleration, using a GPS positioning device to obtain the information of the flight location; the information of the flight path is obtained by means of obtaining the information of the time, position, speed and acceleration of the flight; the flight environment information, such as the temperature, wind speed of the UAV is obtained by means of a temperature sensor and a wind speed sensor; of course, those skilled in the art can also employ other approaches to obtain other flight data of the UAV, as long as by that approach the technical effects achieved in the embodiment can be realized, to which unnecessary details will not be given here.

S12: determining, within a preset period of time, switching times of the UAV between different directions according to the flight data;

where, the specific scope of the preset period of time is not defined and can be set by those skilled in the art according to specific design requirements, for example, the preset period of time can be set as 3 s, 5 s, 10 s, 1 min, and in addition, the different flight directions above can include two different flight directions with a certain angle formed therebetween, such as a combination of any two of east, west, south, north, southeast, northeast, west, southwest and northwest on the map; of course, the different flight directions can also include a plurality of flight directions which are different with a certain angle, such as a combination of any number (greater than two) of east, west, south, north, southeast, northeast, west, southwest and northwest on the map; and the scope of the angles above is not defined, and in particular, it can be set by those skilled in the art according to specific design requirements as long as the effects that the UAV can switch between different directions can be realized, for example, the angle can be set as an acute, obtuse or right angle, to which unnecessary details will not be given here.

In addition, the specific way of determining switching times based on the flight data is not defined and can be set by those skilled in the art according to the specific design requirements, for example, a direction sensor can be set at the UAV and switching times of the UAV can be obtained via the direction sensor; where, the switching in the present embodiment is relative to the flight direction of the UAV at the last moment; in particular, in order to make the switching times of the UAV more clearly, a relative coordinate system can be set in the air, which means that a relative zero is determined according to the flight path of the UAV in the scope of preset space; assuming that the UAV is hovering in the scope of 50-100 m in the front of the horizontal direction, the relative zero of the relative coordinate system can be set as a position of 75 m, so that it can be regarded as one switching each time the UAV traverses 75 m; of course, those skilled in the art can also employ other approaches to determine the switching times of the UAV, as long as the effects above can be achieved, to which unnecessary details will not be given here.

S13: determining whether the UAV has a vibration according to the switching times. In the present disclosure, that the UAV has a vibration may also be referred to as that the UAV is vibrating.

Where, the specific method for determining whether the UAV has a vibration according to the switching times is not defined and can be set by those skilled in the art according to specific design requirements; where, before the determination of those skilled in the art, it can be determined whether the UAV has a vibration according to certain criteria or experience; for example, in the case that the criterion is within the scope of the preset period of time 3 s and the switching times reach 5 or more, then it is determined that the UAV has a vibration; therefore, at this time, it only needs to determine whether the switching times obtained reach 5 or more in the preset period of time.

In addition, those skilled in the art can also classify the vibration into a plurality of levels such as high vibration level, moderate vibration level, low vibration level, no vibration level according to the strength of the vibration, with different levels of vibration conditions corresponding to different vibration determining criteria respectively; in order to make the technical solutions of the present embodiment more apparent, the following specific embodiments are given: assuming that the criterion for the high vibration level is: in the time scope of the preset 3 s, the switching times reach 10 or more; the criterion for the moderate vibration level is: in the time scope of the preset 3 s, the switching times reach 7 or more and less than 10; the criterion for the low vibration level is: in the time scope of the preset 3 s, the switching times reach 5 or more and less than 7; according to the determining criteria above for determining each level of the vibrations, it only needs to analyze the switching times and determine which criterion the obtained switching time falls into, i.e., the vibration conditions of the UAV can be determined accordingly; of course, those skilled in the art can set the specific vibration criteria above according to different design requirements without any limitation to the above specific scope of values; and those skilled in the art can also set other criteria for vibration detection, as long as the effects of determining whether the UAV has a vibration according to the switching times can be realized, to which unnecessary details will not be given here.

In the method for vibration detection of a UAV provided in the present embodiment, the switching times of the UAV between different directions in a preset period of time determined according to the flight data is obtained, and whether the UAV has a vibration and thus generates a vibration are determined according to the switching times, and before it is determined that the vibration magnitude of the UAV is large, the conditions of the UAV is conducted in time to avoid an impact on normal operation and flight of the UAV and even a case of a crash, thus improve the safety and reliability of the flight of the UAV.

### The Second Embodiment

On the basis of the first embodiment above, it can be seen by proceeding to refer to FIG. 1, in order to make clearer the meaning of different flight directions in the step of determining the switching times of the UAV between different directions according to the flight data, the present embodiment sets the different flight directions to include: a first flight direction and a second flight direction, with an angle formed therebetween.

Where, the specific direction features of the first flight direction and the second direction can be set by those skilled in the art according to the specific design requirements, for example, they can be set as a combination of any two of east, west, south, north, southeast, northeast, west, southwest and northwest on the map; alternatively the first or the second flight direction can be set as any direction between any two adjacent directions of the eight directions above; for example, the first flight direction is set as 35° east by south, and the second flight direction is set as 70° west by north, and the like.

In addition, the specific value of the angle formed between the first flight direction and the second flight direction is not defined and can be set by those skilled in the art according to the type and the design requirements of the UAV. For example, the angle can be set as 90°, 180° or 270°. Of course, the angle can also be set as 70°, 80°, 110°, 130° or 150°, etc; in addition, the angle can be set before the flight of the UAV, and can also be set after the flight of the UAV, where, in some embodiments, the angle is set as a preset angle; thus, in the flight process of the UAV, the conditions whether the UAV has a vibration can be known in real time, so that an adjustment can be conducted on the UAV timely to avoid an impact on the flight effect of the UAV and even a case of a crash, thus the safety and reliability of flight of the UAV are improved.

### The Third Embodiment

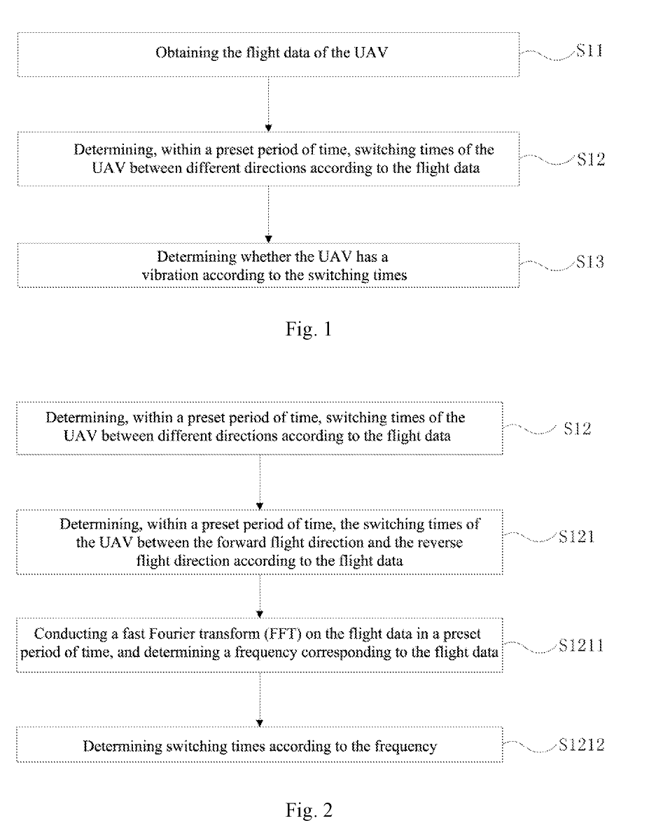

FIG. 2 is a flow diagram of the method for vibration detection of the UAV provided in the second embodiment of the present disclosure; on the basis of the second embodiment, it can be seen by proceeding to refer to FIG. 2, in the case that the angle formed between the first flight direction and the second flight direction is set as 180°, the first flight direction and the second flight direction are opposite to each other; at this time, in order to make the technical solution better understood, the first flight direction is defined as a forward flight direction, and the second direction is defined as a reverse flight direction, thus,

S12: determining, within a preset period of time, switching times of the UAV between different directions according to the flight data, specifically includes:

S121: determining, within a preset period of time, the switching times of the UAV between the forward flight direction and the reverse flight direction according to the flight data.

Where, the specific meanings of the forward flight direction and the reverse flight direction above is not defined and can be set by those skilled in the art according to the specific design requirements. However, due to the cases that occur typically, i.e., leftward and rightward flight vibrations, onward and backward flight vibrations and upward and downward flight vibrations in the flight process of the UAV; where the leftward and rightward flight vibrations refer to the vibrations between the leftward flight and rightward flight of the UAV; the onward and backward flight vibrations refer to the vibrations between the onward flight and backward flight of the UAV; the upward and downward flight vibrations refer to the vibrations between the upward flight and downward flight of the UAV; where, in order to describe the occurrence of the case of the vibration, the leftward flight, onward flight and upward flight of the UAV are defined as the UAV flights along the forward flight direction; accordingly, the rightward flight, backward flight and downward flight of the UAV are defined as the UAV flights along the reverse flight direction; of course, those skilled in the art can also set the forward flight direction and the reverse flight direction in other forms, for example, they can set the forward flight direction to be 35° east by north and the reverse flight direction to be 35° west by south; as long as the forward flight direction is opposite to the reverse flight direction, to which unnecessary details will not be given here.

The switching times, which are determined according to the flight data, of the UAV between different directions, are defined specifically as the switching times of the UAV, which are determined according to the flight data, between the forward flight direction and the reverse flight direction of the UAV. Since the forward flight direction is opposite to the reverse one, the accuracy and reliability of the analysis of the flight data, thus the accuracy and reliability of the vibration detection of the UAV are improved, therefore it is possible to determine whether the UAV has a vibration in the forward and reverse flight directions accurately so as to conduct an adjustment on the UAV timely.

### The Fourth Embodiment

On the basis of the third embodiment above, it can be seen by proceeding to refer to FIG. 2, the specific method, for determining in a preset period of time the switching times of the UAV between the forward and reverse flight directions according to the flight data, is not defined in the present solution, and can be set by those skilled in the art according to the specific design requirements, where, the determining of the switching times can be set as:

S1211: conducting a fast Fourier transform (FFT) on the flight data in a preset period of time, and determining a frequency corresponding to the flight data.

Specifically, the flight data in a preset period of time is collected, and after conducting the FFT on the flight data, a spectrogram is obtained. The frequency information corresponding to the flight data can be visually obtained via the spectrogram; where, the preset period of time and flight data in the present embodiment have the same meanings as those of the preset period of time and flight data in the above embodiments, and in particular, reference can be made to the content described above, to which unnecessary details will not be given here.

S1212: determining switching times according to the frequency.

Where, the specific method for determining the switching times according to the frequency is not defined, and those skilled in the art can set the frequencies and amplitudes for determining the vibration according to the specific design requirements, for example, a scope of standard amplitudes and frequencies can be set to exist; a spectrogram of speed can be obtained according to the speed information, and the amplitudes and frequencies of the spectrogram are analyzed with reference to and compared with the standard amplitudes and frequencies; if there is an amplitude in the spectrum information of the current speed which is greater than or equal to the standard amplitudes and the frequency thereof is in the scope of the standard frequencies, then the UAV is considered to have a vibration; if there is no amplitude in the spectrum information of the current speed which is greater than or equal to the standard amplitude, or the frequency is beyond the scope of the standard frequencies, then the UAV is considered to have not reversed; alternatively, a time domain diagram can be obtained according to the information of the speed, and a direction origin is set in the time domain diagram. If the case that the speed traverses the direction origin in the time domain diagram of the current speed occurs, then it is determined that the UAV has reversed once. Thus, the switching times can be obtained by calculating the number of traversing the direction origin in the time domain diagram; of course, those skilled in the art can also conduct the processing on the information of speed, acceleration, angular speed, etc., by employing other approaches, as long as the switching times are determined according to speed, acceleration, angular speed, etc., to which unnecessary details will not be given here.

The flight data is processed by means of the FFT, and then the frequency corresponding to information of speed, acceleration and angular speed, etc. is obtained. Moreover the switching times are determined by means of the frequency, and the conditions whether the UAV has a vibration can be obtained visually, quickly and accurately, which improves the obtaining efficiency and accuracy for the vibration detection and enables a quick determination of the vibration conditions of the UAV in the flight process, so as to make it possible for a timely adjustment of the UAV and further ensure the safety and reliability of the flight of the UAV.

### The Fifth Embodiment

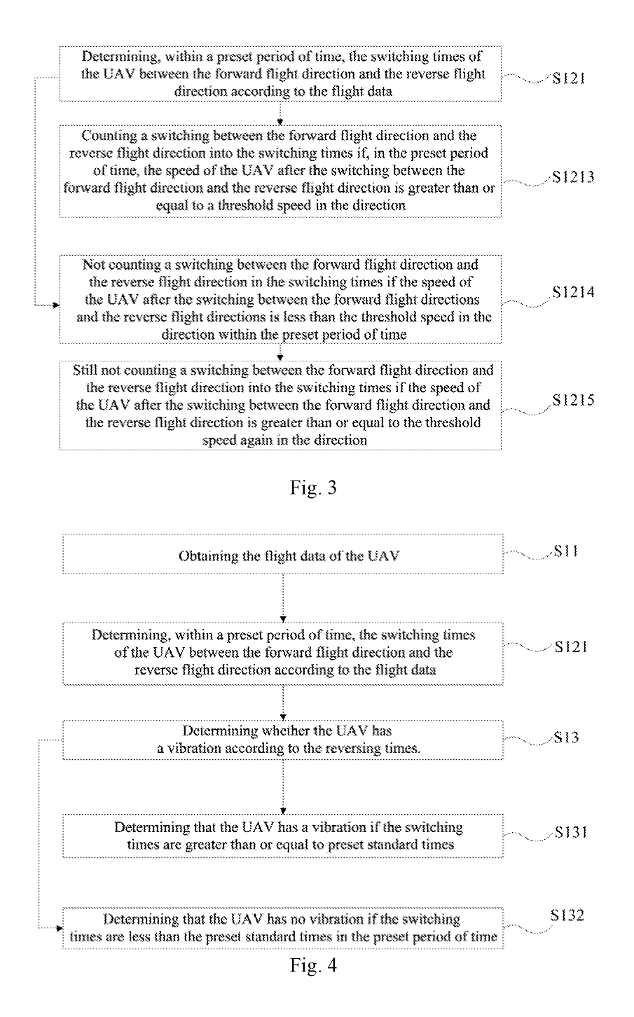

FIG. 3 is a flow diagram of a method for vibration detection of the UAV provided in the third embodiment of the present disclosure; it can be seen with reference to FIG. 3, in the fourth embodiment above, the flight data is processed using an FFT; although the above method can ensure the efficiency and accuracy of the processing of flight data, the consumption of the processor and the memory is large when the FFT is used to process the flight data, i.e., most of the resources of the processor and memory can be occupied, which will easily result in a case that the processor and memory are unable to handle the control of other devices timely; and at the moment when the UAV starts, if the flight data are processed by the method above, it is easy to result in a false detection, thus have an impact on the determination of the flight conditions of the UAV by the system; based on the above existing circumstances, another method for processing flight data is provided in the present embodiment, particularly as follows:

S121: determining, within a preset period of time, switching times of the UAV between different directions according to the flight data, further includes:

S1213: counting a switching between the forward flight direction and the reverse flight direction into the switching times if, in the preset period of time, the speed of the UAV after the switching between the forward flight direction and the reverse flight direction is greater than or equal to a threshold speed in the direction.

Where, the flight data is specifically defined as the flight speed in the present embodiment. Through the overall analysis of the flight speed and flight direction, the switching times of the UAV is determined; in particular, the threshold speed of the embodiment can be a preset threshold speed, and then the speed after the switching of the UAV between the forward flight direction and the reverse flight direction is obtained, where, the speed of the UAV after the switching between the forward flight direction and the reverse flight direction refer to: if at previous moment, the UAV is flying in a forward direction; but at the next moment, the UAV is flying in a reverse direction, then at the time between the previous and the subsequent moments, the UAV switches from the forward flight direction to the reverse flight direction. After the switching to the reverse flight direction, the flight speed of the UAV in the reverse flight direction is obtained, and the flight speed at this moment is the speed of the UAV after the switching from the forward flight direction to the reverse flight direction; similarly, the situation in which the UAV switches from the reverse flight direction to the forward flight direction is similar to the situation above, and in particular, reference can be made to the content described above, to which unnecessary details will not be given here.

Then, after a switched speed is obtained, the speed needs to be compared with the threshold speed. The specific scope of the threshold speed is not defined in the present embodiment and can be set by those skilled in the art according to specific design requirements; and step of counting a switching between the forward flight direction and the reverse flight direction into the switching times if the speed is greater than or equal to the threshold speed refers to: after the UAV switches from the forward flight direction to the reverse flight direction, if the speed of the reverse flight is greater than or equal to the threshold speed, then the switching is counted as one switching.

In the embodiment the analysis and processing are conducted on the speed directly so as to reduce the consumptions of the processor and the memory of the UAV, and then improve the processing ability of the processor and memory of the UAV; moreover, the situation of false detection of the UAV at the moment of the start is avoided by employing the method; thus the practicability of the method, the accuracy and reliability of the adjustment and control of the UAV are improved.

### The Sixth Embodiment

On the basis of the fifth embodiment above, it can be seen by proceeding to refer to FIG. 3, in the processing of the speed after the switching between the forward flight direction and the reverse flight direction and the threshold speed of the direction, there are not only the case that the speed is greater than or equal to the threshold speed in the direction, but also other cases, in particular as follows,

S121: determining, within a preset period of time, switching times of the UAV between different directions according to the flight data, further includes:

S1214: not counting a switching between the forward flight direction and the reverse flight direction in the switching times if the speed of the UAV after the switching between the forward flight directions and the reverse flight directions is less than the threshold speed in the direction within the preset period of time.

Where, the operation process and the implementing effect of the present embodiment are similar to those in the step 1213 of the fifth embodiment above, except that the speed after the switching in the present embodiment is less than the threshold speed, whereas the speed after the switching in the fifth embodiment is greater than the threshold speed in the direction, thus for the specific operation and implementing effect reference can be made to the above contents, to which unnecessary details will not be given here.

### The Seventh Embodiment

On the basis of the sixth embodiment above, it can be seen by proceeding to refer to FIG. 3, after not counting a switching between the forward flight direction and the reverse flight direction into the switching times, the method further includes:

S1215: still not counting a switching between the forward flight direction and the reverse flight direction into the switching times if the speed of the UAV after the switching between the forward flight direction and the reverse flight direction is greater than or equal to the threshold speed in the direction.

Where, when the speed after the switching is less than the threshold speed, there will be two different cases, that is, the first case: after the UAV switches again, the speed after the switching is less than the threshold speed; the second case: after the UAV switches again, the speed after the switching is greater than or equal to the threshold speed; in the above two cases, such switching is not counted into the switching times; for a more clear understanding of the technical solution of the present disclosure, the following embodiments are given to obtain a plurality of flight speeds of the UAV according to the time order, where, “+” and “−” represent a forward direction and a reverse direction respectively, and the speed values below are obtained:

the first group: V10: −20 km/h, V11: +35 km/h, V12: −25 km/h, V13: +32 km/h, V14: −40 km/h;

the second group: V20: −20 km/h, V21: +35 km/h, V22: −31 km/h, V23: +32 km/h, V24: −40 km/h;

where, it is assumed that the threshold speeds of the first and second groups are: V+: +30 km/h, V−: −30 km/h.

Then analysis of the speed value of the first group above is as follows: the switching of the flight directions occurs between V10 and V11, and since the speed V11 after the switching is greater than V+, the switching is counted in the switching times; then a direction switching occurs between V11 and V12, and since the speed V12 after the switching is less than V−, the switching is not counted into the switching times; next, the switching of the flight directions occurs between V12 and the V13 again, and the speed V13 after the switching is greater than V+, then the switching is not counted in the switching times again; sequentially, the switching of the flight directions occurs between the V13 and the V14 again, and the speed V14 after the switching is greater than V−, then the switching is counted into the switching times; based on the above analysis process, it can be obtained that the switching times of the speed data in the first group is 2.

The analysis of the second group of speed values is as follows: the switching of the flight directions occurs between V10 and V11, and since the speed V11 after the switching is greater than V+, the switching is counted into the switching times; next, the switching of the flight directions occurs between V11 and V12, and since the speed V12 after the switching is greater than V−, the switching is counted in the switching times; next, the switching of the flight directions occurs between V12 and V13 again, and the speed V13 after the switching is greater than V+, then the switching is counted in the switching times again; sequentially, the switching of the flight directions occurs between V13 and V14 again, and the speed V14 after the switching is greater than V−, then the switching is counted in the switching times; based on the above analysis process, it can be obtained that the switching times of the speed data in the first group is 4.

That is to say, there is a special definition of the switching times in the present embodiment, in the premise of the switching of the UAV, if the speed of the forward flight direction after the switching is greater than or equal to the threshold speed in the forward direction and the reverse flight speed is greater than or equal to the reverse speed are alternately implemented, then the switching is counted in the switching times; if the speed of the forward flight direction after the switching is greater than or equal to the threshold speed in the forward direction and the reverse flight speed is greater than or equal to the reverse speed are not alternately implemented, then the switching is not counted in the switching times.

### The Eighth Embodiment

FIG. 4 is a flow diagram of the method for vibration detection of the UAV provided in the fourth embodiment of the present disclosure; on the basis of the embodiments above, it can be seen by proceeding to refer to FIG. 4, the specific method for determining whether the UAV has a vibration according to the switching times is not defined in the present embodiment and can be set by those skilled in the art according to the specific design requirements, where in some embodiments, it can be determined whether the UAV has a vibration according to the switching times, and the setting specifically includes:

S131: determining that the UAV has a vibration if the switching times are greater than or equal to preset standard times; or,

where, the specific scope of the standard times is not defined and can be set by those skilled in the art according to the length of the preset period of time according to different design requirements; in principle, the longer the preset period of time is, the greater the value of the standard times will be; for example: if the preset period of time is assumed to be 3 s, then the value of corresponding standard times is 5; if the preset period of time is extended to 5 s, the corresponding value of standard times is 8, which ensures an accurate determination of whether the UAV has a vibration.

S132: determining that the UAV has no vibration if the switching times are less than the preset standard times in the preset period of time.

Of course, those skilled in the art can also employ other methods to determine whether the UAV has a vibration; for example, the vibrations are classified into a plurality of levels according to the strength of the vibration; therefore, with each level corresponding to a different criterion, the data collected are compared with different criteria to determine whether the UAV has a vibration or how large the vibration is, etc.; as long as it can be determined accurately whether the UAV has a vibration, the method will be valid, to which unnecessary details will not be given here.

### The Ninth Embodiment

On the basis of the third embodiment above, it can be seen by proceeding to refer to FIG. 2, the forward flight directions and the reverse flight directions are not defined in the technical solution and can be set by those skilled in the art according to the specific design requirements:

For example, in one dimension, the forward flight direction is set as the forward direction of any coordinate axis of an X-axis, a Y-axis and a Z-axis in a three-dimensional space of the coordinate system which is composed of the X-axis, the Y-axis and the Z-axis; accordingly, the reverse flight direction is set as the reverse direction of any coordinate axis of the X-axis, the Y-axis and the Z-axis.

Where, the specific directions of the X-axis, the Y-axis and the Z-axis are not defined and can be set by those skilled in the art differently according to their own habits. For example, the X-axis can be set as the onward-to-backward direction of the horizontal, or set as the leftward-to-rightward direction of the horizontal, or set as the upward-to-downward direction of the vertical; usually, the X-axis refers to the onward-to-backward direction, the Y-axis refers to the leftward-to-rightward direction, and the Z-axis refers to the upward-to-downward direction; however, the forward direction of the axis can be set arbitrarily, for example, the onward, leftward and upward directions can be set as the forward directions, then the backward, rightward and downward directions accordingly are the reverse directions; alternatively the backward, rightward and downward directions can be set as the forward directions, then the onward, leftward and upward directions accordingly are reverse directions, as long as the forward flight directions and the reverse flight directions of the UAV can be determined clearly, to which unnecessary details will not be given here.

### The Tenth Embodiment

On the basis of the third embodiment above, it can be seen by proceeding to refer to FIG. 2, the forward flight directions and the reverse flight directions are not defined in the technical solution and can be set by those skilled in the art according to specific design requirements:

In two dimensions, the forward flight directions are set as a first direction of any two coordinate axes of an X-axis, a Y-axis and a Z-axis in a three-dimensional space of the coordinate system which is composed of the X-axis, the Y-axis and the Z-axis; accordingly, the reverse directions are set as a direction of any two coordinate axes of the X-axis, the Y-axis and the Z-axis, opposite to the first direction.

Where, the specific directions of the X-axis, the Y-axis and the Z-axis are not defined and can be set by those skilled in the art differently according to their own habits. For example, the X-axis can be set as the onward-to-backward direction of the horizontal, or the leftward-to-rightward direction of the horizontal, or the upward-to-downward direction of the vertical; usually, the X-axis refers to the onward-to-backward direction, the Y-axis refers to the leftward-to-rightward direction, and the Z-axis refers to the upward-to-downward direction; however, the forward direction of the axis can be set arbitrarily, e.g., the onward, leftward and upward directions can be set as the forward directions, then the backward, rightward or downward directions accordingly are reverse directions; alternatively the backward, rightward and downward directions can be set as the forward directions, then the onward, leftward and upward directions accordingly are reverse directions.

Then, the first direction of the embodiment can be set by those skilled in the art according to the specific design requirements, e.g., supposing that it is in the two-dimensional plane of the X-axis and the Y-axis, those skilled in the art can set the region formed by the forward direction of any one of the X-axis and the Y-axis and the other axis is a forward flight direction, accordingly, the region formed by the reverse direction of the coordinate axis determined in the X-axis or the Y-axis and the other coordinate axis is a reverse flight direction; alternatively, the plane formed by the X-axis and the Y-axis is divided equally via a straight line which traverses the origin where the X-axis intersects with the Y-axis, then the region where the straight line and the forward direction of any coordinate axis of the X-axis and the Y-axis lie in is regarded as the first direction, accordingly, the region where the straight line and the determined reverse direction of the coordinate axis of the X-axis or the Y-axis lie is regarded as the reverse direction opposite to the first direction; of course, those skilled in the art can also employ other ways of setting, as long as they can distinguish the forward flight directions and the reverse directions of flight accurately and reliably, to which unnecessary details will not be given here.

### The Eleventh Embodiment

On the basis of the third embodiment above, it can be seen by proceeding to refer to FIG. 2, the forward flight directions and the reverse flight directions are not defined in the technical solution and can be set by those skilled in the art according to the specific design requirements:

In three dimensions, the forward flight direction is set as the second direction of an X-axis, a Y-axis and a Z-axis in a three-dimensional space of the coordinate system which is composed of the X-axis, the Y-axis and the Z-axis; accordingly, the reverse flight direction is the direction opposite to the second direction of the X-axis, the Y-axis and the Z-axis.

Where, the meanings of the X-axis, the Y-axis and the Z-axis in the present embodiment is the same as those in the ninth embodiment above, and in particular, reference can be made to the content described above, to which unnecessary details will not be given here; in addition, the second direction of the embodiment can be set by those skilled in the art according to the specific design requirements, e.g., the second direction can be set as the region enclosed by the forward direction of any one of the X-axis, the Y-axis and the Z-axis and the plane formed by the other two axes; accordingly, the reverse direction opposite to the second direction is the region enclosed by the reverse direction of the determined axis and the plane formed by the other two axes; of course, those skilled in the art can also employ other ways of setting, as long as they can distinguish the forward flight directions and the reverse flight directions accurately and reliably, to which unnecessary details will not be given here.

### The Twelfth Embodiment

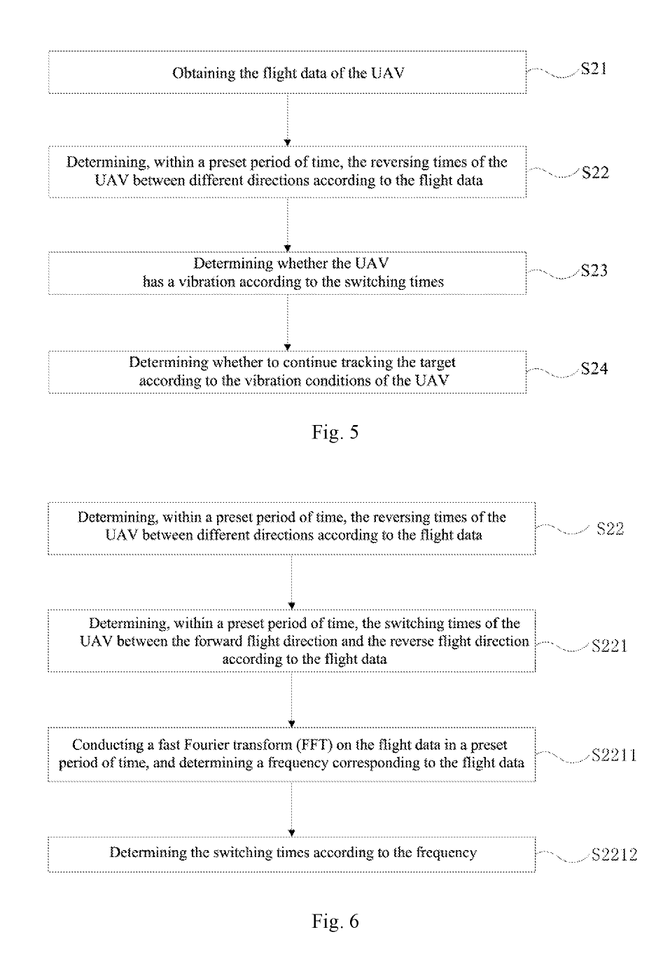

A method for tracking control of the UAV is provided in the present embodiment. And FIG. 5 is a flow diagram of the method for vibration detection of the UAV provided in the first embodiment of the present disclosure; as shown in FIG. 5, the method for tracking control of the UAV includes:

S21: obtaining the flight data of the UAV;

Where, the type of the flight data of the UAV and the means of the obtaining are not defined and can be set by those skilled in the art according to the specific design requirements, e.g., the flight data can be set as a combination of any one or more of the flight direction, flight path, flight speed, flight acceleration, flight location and flight environment; and based on the different flight data above, those skilled in the art can employ different means of obtaining data, e.g., information of the flight direction is obtained via a direction sensor, the information of the flight speed or flight acceleration via a speed sensor or an acceleration sensor, and the information of the flight location via the set GPS positioning device; the information of the flight path is obtained by obtaining the information of the time, position, speed and acceleration of the flight; the flight environment information such as the temperature and wind speed the UAV is obtained by a temperature sensor and a wind speed sensor; of course, other approaches can be employed by those skilled in the art to obtain other flight data of the UAV as long as the technical effects are achieved in the embodiment, to which unnecessary details will not be given here.

S22: determining, within a preset period of time, the switching times of the UAV between different directions according to the flight data;

Where, the specific scope of the preset period of time is not defined and can be set by those skilled in the art according to the specific design requirements. For example, the preset period of time can be set as 3 s, 5 s, 10 s, 1 min. In addition, the different flight directions above can include two flight directions which are different with a certain angle, such as a combination of any two of east, west, south, north, southeast, northeast, west, southwest and northwest on the map; of course, the different flight directions can also include a plurality of flight directions which are different with a certain angle, such as a combination of any number (greater than two) of east, west, south, north, southeast, northeast, west, southwest and northwest on the map; and the scope of the angles above is not defined and, in particular, can be set by those skilled in the art according to the specific design requirements. For example, the angle can be set as an acute, obtuse or right angle, as long as the effects that the UAV can switch between different directions can be achieved, to which unnecessary details will not be given here.

In addition, the specific method for determining switching times based on the flight data is not defined and can be set by those skilled in the art according to the specific design requirements. For example, a direction sensor can be set at the UAV, and the switching times of the UAV can be obtained via the direction sensor; where, the switching in the present embodiment is relative to the flight direction of the UAV at the last moment; in particular, in order to make the switching times of the UAV more clearly understood, the relative coordinates can be set in the air, and the meaning of the relative coordinates is: in the scope of the preset space, the relative zero is determined according to the flight path of the UAV; assuming that the UAV is hovering in the scope of 50-100 m in the front of the horizontal direction, the relative zero of the relative coordinates can be set as the position of 75 m, so that it can be regarded as one switching each time the UAV traverses 75 m of course, other approaches can also be employed by those skilled in the art to determine the switching times of the UAV, as long as the effects above are achieved, to which unnecessary details will not be given here.

S23: determining whether the UAV has a vibration according to the switching times.

Where, the specific method for determining whether the UAV has a vibration according to the switching times is not defined and can be set by those skilled in the art according to specific design requirements; where, before the determination is conducted by those skilled in the art, whether the UAV has a vibration can be determined according to certain criteria or experience; for example, if the criterion for determining that the UAV has a vibration is that the switching times reach 5 or more within the scope of the preset period of time 3 s, then it is determined that the UAV has a vibration; thus at this time, it only needs to determine whether the switching times obtained reach 5 or more in the preset period of time.

In addition, those skilled in the art can also classify the vibrations into a plurality of levels such as high vibration level, moderate vibration level, low vibration level, and no vibration level according the strength of the vibration, with different levels of vibration conditions above corresponding to different criteria for determining the vibration respectively; in order to make the technical solutions of the present embodiment more clearly understood, the following specific embodiments are given: assuming that the criterion for the high vibration level is: in the time scope of the preset 3 s, the switching times reach 10 or more; the criterion for the moderate vibration level is: in the time scope of the preset 3 s, the switching times reach 7 or more and are less than 10; the criterion for the low vibration level is: in the time scope of the preset 3 s, the switching times reach 5 or more and are less than 7; the criterion for no vibration level is: in the time scope of the preset 3 s, the switching times are less than 5; according to the determining criteria above for determining each level of the vibrations, it only needs to analyze the switching times and determine which criterion the obtained switching time falls into, then the vibration conditions of the UAV can be determined accordingly; of course, those skilled in the art can set the specific criteria of vibration above according to different design requirements, and the setting is not limited to the specific scope of values above; and those skilled in the art can also set other criteria for vibration detection, as long as the effect of determining whether the UAV has a vibration can be achieved according to the switching times, to which unnecessary details will not be given here.

S24: determining whether to continue tracking the target according to the vibration conditions of the UAV. That is, determining whether to continue tracking the target according to whether the UAV is vibrating.

Where, the control policies for determining whether to continue tracking the target according to the vibration conditions of the UAV is not defined and can be set by those skilled in the art according to the specific design requirements. For example, it can be set as: if the UAV has a vibration, in order to ensure the normal flight of the UAV, stopping tracking the target so as to avoid the case of a crash when the vibration range is large; if it is determined that the UAV has no vibration, then it can be set as continuing tracking the target; or the vibration conditions are classified into a plurality of levels of vibration such as high strength vibration, moderate strength vibration, low strength vibration and no vibration according to the strength of the vibration; at this time, it can be set as: if the vibration conditions are the high strength vibration or the moderate strength vibration, in order to ensure the normal flight of the UAV, stopping tracking the target; if the vibration conditions are the low vibration or no vibration, continuing to tracking the target; of course, those skilled in the art can also employ other control policies, as long as the functions above are achieved, to which unnecessary details will not be given here.

A method for tracking control of the UAV provided in the embodiment can achieve, before determining the UAV has a large vibration extent, a timely adjustment on the condition of the UAV to avoid an impact on the normal tracking, flight and even the case of a crash, thus improves the safety and reliability of the flight of the UAV by in the preset period of time, determining the switching times of the UAV between different directions according to the flight data; determining whether the UAV has a vibration thus generates a vibration according to the switching times, and determining whether to continue tracking the target according to the vibration conditions of the UAV.

### The Thirteenth Embodiment

On the basis of the twelfth embodiment above, it can be seen by proceeding to refer to FIG. 5, in order to make it clearer of the meaning of the different flight directions in the expression “determining the switching times of the UAV between different flight directions according to the flight data”, the present embodiment sets the different flight directions to include: the first flight direction and the second flight direction, with an angle formed therebetween.

Where, the specific direction features of the first flight direction and the second direction can be set by those skilled in the art according to the specific design requirements, e.g., they can be set as a combination of any two of east, west, south, north, southeast, northeast, west, southwest and northwest on the map; or the first flight direction and the second flight direction can also be set as any direction between any two adjacent directions of the eight directions above; such as the first flight direction is set as 35° east by south, the second flight direction is set as 70° west by north.

In addition, the specific value of the angle formed between the first flight direction and the second flight direction is not defined and can be set by those skilled in the art according to the type and the design requirements of the UAV. For example, the angle can be set as 90°, 180° or 270°. Of course, the angle can also be set as 70°, 80°, 110°, 130° or 150°, etc; in addition, the angle can be set before the flight of the UAV, and can also be set after the flight of the UAV, where, in some embodiments, the angle is set as a preset angle; thus, in the flight process of the UAV, the conditions whether the UAV has a vibration can be known in real time, so that an adjustment can be conducted on the UAV timely to avoid an impact on the flight effect of the UAV and even a case of a crash, thus the safety and reliability of flight of the UAV are improved.

### The Fourteenth Embodiment

FIG. 6 is a flow diagram of the method for tracking control of the UAV provided in the second embodiment of the present disclosure; on the basis of the above embodiment, it can be seen by proceeding to refer to FIG. 6, in the case that the angle formed between the first flight direction and the second flight direction is set as 180°, the first flight direction and the second flight direction are opposite to each other; at this time, in order to make the technical solution better understood, the first flight direction is defined as a forward flight direction, and the second direction is defined as a reverse flight direction, thus,

S22: determining, within a preset period of time, switching times of the UAV between different directions according to the flight data, specifically includes:

S221: determining, within a preset period of time, the switching times of the UAV between the forward flight direction and the reverse flight direction according to the flight data.

Where, the specific implementing process and the implementing effect of S221 in the present embodiment are the same as those of the S121 in the third embodiment described above, and in particular, reference can be made to the content described above, to which unnecessary details will not be given here.

The switching times, which are determined according to the flight data, of the UAV between different directions, are defined specifically as the switching times of the UAV, which are determined according to the flight data, between the forward flight direction and the reverse flight direction of the UAV. Since the forward flight direction is opposite to the reverse one, the accuracy and reliability of the analysis of the flight data, thus the accuracy and reliability of the vibration detection of the UAV are improved, therefore it is possible to determine whether the UAV has a vibration in the forward and reverse flight directions accurately so as to conduct a effective adjustment and control on the UAV, ensure the flight effect of the UAV, improve the extent of regulating and controlling the tracking target and thus the practicality of the method.

### The Fifteenth Embodiment

On the basis of the fourteenth embodiment above, it can be seen by proceeding to refer to FIG. 6, the specific method, for determining in a preset period of time the switching times of the UAV between the forward and reverse flight directions according to the flight data, is not defined in the present solution, and can be set by those skilled in the art according to the specific design requirements, where, the determining of the switching times can be set as:

S2211: conducting a fast Fourier transform (FFT) on the flight data in a preset period of time, and determining a frequency corresponding to the flight data;

Specifically, the flight data in a preset period of time is collected, and after conducting the FFT on the flight data, a spectrogram is obtained. The frequency information corresponding to the flight data can be visually obtained via the spectrogram; where, the preset period of time and flight data in the present embodiment have the same meanings as those of the preset period of time and flight data in the above embodiments, and in particular, reference can be made to the content described above, to which unnecessary details will not be given here.

S2212: determining switching times according to the frequency.

Where, the specific implementing process and the implementing effect of S2221 in the present embodiment are the same as those of the S1212 in the fourth embodiment described above, and in particular, reference can be made to the content described above, to which unnecessary details will not be given here.

The flight data is processed by means of the FFT, and then the frequency corresponding to information of speed, acceleration and angular speed, etc. is obtained. Moreover the switching times are determined by means of the frequency, and the conditions whether the UAV has a vibration can be obtained visually, quickly and accurately, which improves the obtaining efficiency and accuracy for the vibration detection and enables a quick determination of the vibration conditions of the UAV in the flight process, so as to make it possible for a timely adjustment of the UAV and further ensure the safety and reliability of the flight of the UAV.

### The Sixteenth Embodiment

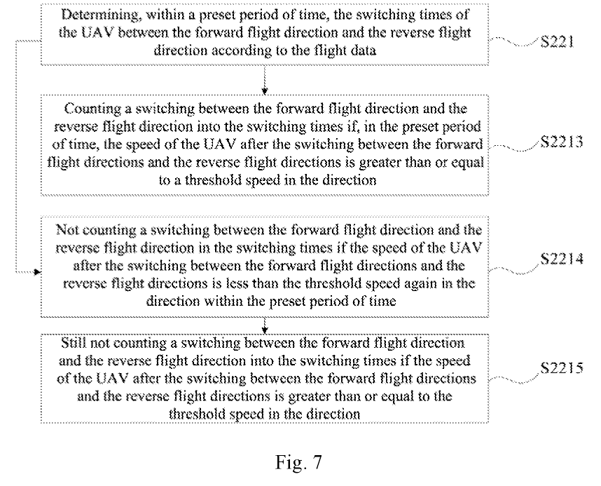

FIG. 7 is a flow diagram of a method for tracking control of the UAV provided in the third embodiment of the present disclosure; it can be seen with reference to FIG. 7, in the fifteenth embodiment above, the flight data is processed using an FFT; although the above method can ensure the efficiency and accuracy of the processing of flight data, the consumption of the processor and the memory is large when the FFT is used to process the flight data, i.e., most of the resources of the processor and memory can be occupied, which will easily result in a case that the processor and memory are unable to handle the control of other devices timely; and at the moment when the UAV starts, if the flight data are processed by the method above, it is easy to result in a false detection, thus have an impact on the determination of the flight conditions of the UAV by the system; based on the above existing circumstances, another method for processing flight data is provided in the present embodiment, particularly as follows:

S221: determining, within a preset period of time, switching times of the UAV between different directions according to the flight data, further includes:

S2213: counting a switching between the forward flight direction and the reverse flight direction into the switching times if, in the preset period of time, the speed of the UAV after the switching between the forward flight directions and the reverse flight directions is greater than or equal to a threshold speed in the direction.

Where, the specific implementing process and the implementing effect of S2213 in the present embodiment are the same as those of the S1213 in the fifth embodiment described above, in particular, reference can be made to the content described above, to which unnecessary details will not be given here.

In the embodiment the analysis and processing are conducted on the speed directly so as to reduce the consumptions of the processor and the memory of the UAV, and then improve the processing ability of the processor and memory of the UAV; moreover, the situation of false detection of the UAV at the moment of the start is avoided by employing the method; thus the practicability of the method, the accuracy and reliability of the adjustment and control of the UAV are improved.

### The Seventeenth Embodiment

On the basis of the sixteenth embodiment above, it can be seen by proceeding to refer to FIG. 7, in the processing of the speed after the switching between the forward flight direction and the reverse flight direction and the threshold speed of the direction, there are not only the case that the speed is greater than or equal to the threshold speed in the direction, but also other cases, in particular as follows,

S221: determining, within a preset period of time, switching times of the UAV between different directions according to the flight data, further includes:

S2214: not counting a switching between the forward flight direction and the reverse flight direction in the switching times if the speed of the UAV after the switching between the forward flight directions and the reverse flight directions is less than the threshold speed in the direction within the preset period of time.

Where, the operation process and the implementing effect of the present embodiment are similar to those in the step 2213 of the fifteenth embodiment above, except that the speed after the switching in the present embodiment is less than the threshold speed, whereas the speed after the switching in the fifteenth embodiment is greater than the threshold speed in the direction, thus for the specific operation and implementing effect reference can be made to the above contents, to which unnecessary details will not be given here.

### The Eighteenth Embodiment

On the basis of the seventh embodiment above, it can be seen by proceeding to refer to FIG. 7, after not counting a switching between the forward flight direction and the reverse flight direction into the switching times, the method further includes:

S2215: still not counting a switching between the forward flight direction and the reverse flight direction into the switching times if the speed of the UAV after the switching between the forward flight directions and the reverse flight directions is greater than or equal to the threshold speed in the direction.

Where, the specific implementing process and the implementing effect of S2215 in the present embodiment are the same as those of the S1215 in the seventh embodiment described above, and in particular, reference can be made to the content described above, to which unnecessary details will not be given here.

### The Nineteenth Embodiment

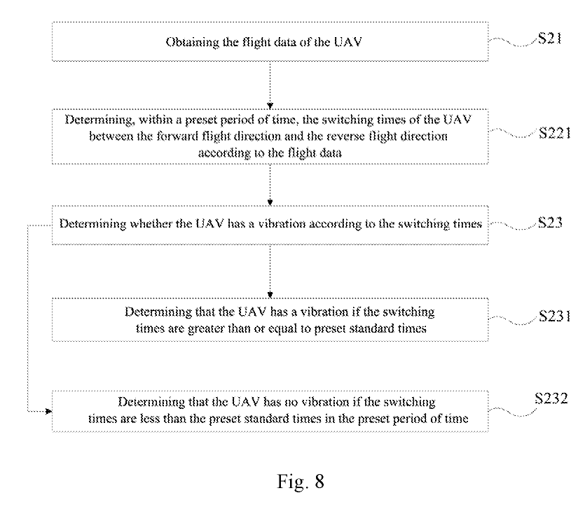

FIG. 8 is a flow diagram of the method for tracking control of the UAV provided in the fourth embodiment of the present disclosure; on the basis of the embodiments above, it can be seen by proceeding to refer to FIG. 8, the specific method for determining whether the UAV has a vibration according to the switching times is not defined in the present embodiment and can be set by those skilled in the art according to the specific design requirements, where in some embodiments, it can be determined whether the UAV has a vibration according to the switching times, and the setting specifically includes:

S231: determining that the UAV has a vibration if the switching times are greater than or equal to preset standard times; or,

where, the specific scope of the standard times is not defined and can be set by those skilled in the art according to the length of the preset period of time according to different design requirements; in principle, the longer the preset period of time is, the greater the value of the standard times will be; for example: if the preset period of time is assumed to be 3 s, then the value of corresponding standard times is 5; if the preset period of time is extended to 5 s, the corresponding value of standard times is 8, which ensures an accurate determination of whether the UAV has a vibration.

S232: determining that the UAV has no vibration if the switching times are less than the preset standard times in the preset period of time.

Of course, those skilled in the art can also employ other methods to determine whether the UAV has a vibration; for example, the vibrations are classified into a plurality of levels according to the strength of the vibration; therefore, with each level corresponding to a different criterion, the data collected are compared with different criteria to determine whether the UAV has a vibration or how large the vibration is, etc.; as long as it can be determined accurately whether the UAV has a vibration, the method will be valid, to which unnecessary details will not be given here.

### The Twentieth Embodiment

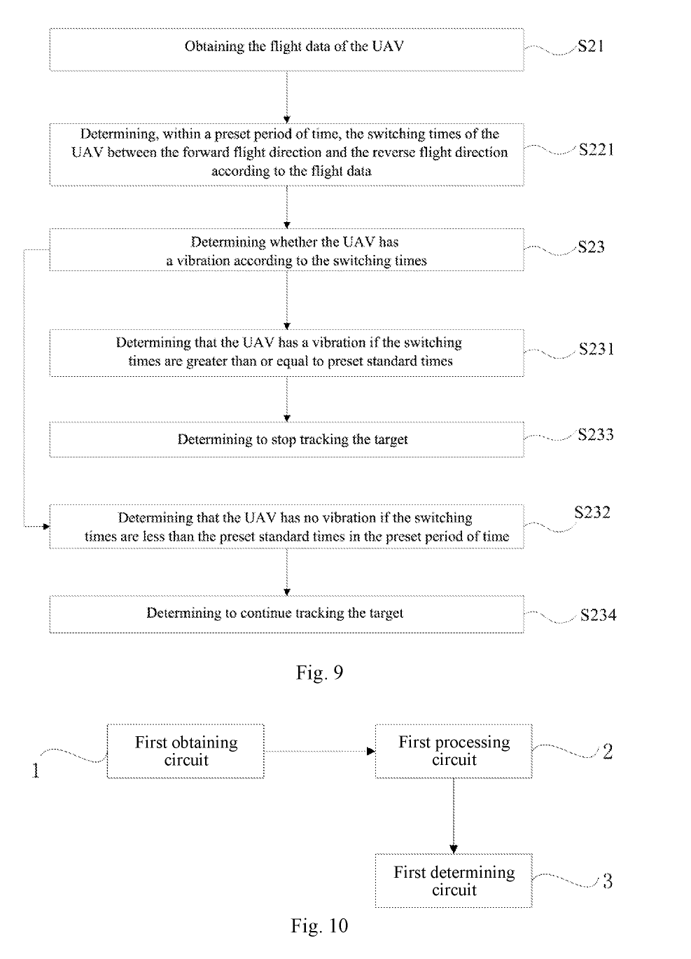

FIG. 9 is a flow diagram of the method for tracking control of the UAV provided in the fifth embodiment of the present disclosure; on the basis of the embodiment above, it can be seen by referring to FIG. 9, the control policy of determining whether to continue tracking the target according to the vibration conditions of the UAV is not defined in the technical solution and can be set by those skilled in the art according to the specific design requirements, where in some embodiments, the setting for determining whether to continue tracking the target according to the vibration conditions of the UAV specifically include:

S233: determining to stop tracking the target if it is determined that the UAV has a vibration; or,

where, if it is determined that the UAV has a vibration, then it implies that when the UAV tracks the target, a vibration occurs due to external factors or internal factors, where, the external factors include temperature, humidity, wind speed, air flow etc., and the internal factors include the case that when the tracking the target, the UAV determines the target via a locked frame, and then compares the size of the target with the that of the preset target. Due to the distance from the target to the UAV, the size of the target may differ greatly from the size of the preset target size. Thus the speed change of the locked frame is very large, then the control speed of the UAV also changes greatly in a magnitude of expression. The UAV at this time performs to be e.g., vibrating back and forth vibration; for the UAV above having a vibration due to the external factors, the flight conditions of the UAV can be adjusted timely, and the control over the tracking task of the UAV is not needed; if the UAV has a vibration due to the internal factors above, the conditions of the UAV is not appropriate for continuing tracking the target. Accordingly, in order to ensure the effects of the normal flight of the UAV, it is necessary to stop the task of target tracking timely; and to timely and effectively adjust the UAV until it returns to the normal flight conditions, and the task of target tracking can also be started here at this time.

S234: determining to continue tracking the target if it is determined that the UAV has no vibration,

if it is determined that the flight conditions of the UAV has no vibration, on the basis of ensuring the normal flight of the UAV, the task of target tracking is continued so as to improve the stability and the reliability of target tracking of the UAV.

### The Twenty-First Embodiment

On the basis of the fourteenth embodiment above, it can be seen by proceeding to refer to FIG. 6, the forward flight directions and the reverse flight directions are not defined in the technical solution and can be set by those skilled in the art according to the specific design requirements:

For example, in one dimension, the forward flight direction is set as the forward direction of any coordinate axis of an X-axis, a Y-axis and a Z-axis in a three-dimensional space of the coordinate system which is composed of the X-axis, the Y-axis and the Z-axis; accordingly, the reverse flight direction is set as the reverse direction of any coordinate axis of the X-axis, the Y-axis and the Z-axis.

Where, the specific directions of the X-axis, the Y-axis and the Z-axis are not defined and can be set by those skilled in the art differently according to their own habits. For example, the X-axis can be set as the onward-to-backward direction of the horizontal, or set as the leftward-to-rightward direction of the horizontal, or set as the upward-to-downward direction of the vertical; usually, the X-axis refers to the onward-to-backward direction, the Y-axis refers to the leftward-to-rightward direction, and the Z-axis refers to the upward-to-downward direction; however, the forward direction of the axis can be set arbitrarily, for example, the onward, leftward and upward directions can be set as the forward directions, then the backward, rightward and downward directions accordingly are the reverse directions; alternatively the backward, rightward and downward directions can be set as the forward directions, then the onward, leftward and upward directions accordingly are reverse directions, as long as the forward flight directions and the reverse flight directions of the UAV can be determined clearly, to which unnecessary details will not be given here.

### The Twenty-Second Embodiment

A vibration detection system of the UAV is provided in the present embodiment. FIG. 10 is a schematic diagram of the system for vibration detection of the UAV provided in the first embodiment of the present disclosure. It can be seen by reference to FIG. 10, the vibration detection system of the UAV, includes:

a first obtaining circuit 1, configured to obtain flight data of the UAV;

a first processing circuit 2, configured to determine the switching times of the UAV between different flight directions in a preset period of time according to the flight data;

a first determining circuit 3, configured to determine whether the UAV has a vibration according to the switching times.

Where, the specific structures of the first obtaining circuit 1, the first processing circuit 2 and the first determining circuit 3 above are not defined and can be set by those skilled in the art arbitrarily according to the functions implemented by each circuit above; in addition, the implementing process and the implementing effects of the functions implemented by the first obtaining circuit 1, the first processing circuit 2 and the first determining circuit 3 are the same as those of the steps S11-S13 in the first embodiment above, and in particular, reference can be made to the content described above, to which unnecessary details will not be given here.

In the system for vibration detection of the UAV provided in the present embodiment, the first obtaining circuit 1 obtains the flight data in the preset period of time, then the first processing circuit 2 determines the switching times of the UAV between different directions according to the flight data, and the first determining circuit 3 determines whether the UAV has a vibration according to the switching times, and next the conditions of the UAV can be adjusted timely before it is determined that the UAV has a large magnitude of vibration so as to avoid an impact on the normal operation and flight of the UAV and even a case of a crash, thus to ensure the safety and reliability of the flight of the UAV and improve the practicability of the system for vibration detection system of the UAV.

### The Twenty-Third Embodiment

On the basis of the embodiments above, it can be seen by proceeding to refer to FIG. 10, in order to make clearer the meaning of different flight directions in the step of determining the switching times of the UAV between different directions according to the flight data, the present embodiment sets the different flight directions to include: a first flight direction and a second flight direction, with an angle formed therebetween.

Where, the specific direction features of the first flight direction and the second direction can be set by those skilled in the art according to the specific design requirements, for example, they can be set as a combination of any two of east, west, south, north, southeast, northeast, west, southwest and northwest on the map; alternatively the first or the second flight direction can be set as any direction between any two adjacent directions of the eight directions above; for example, the first flight direction is set as 35° east by south, and the second flight direction is set as 70° west by north, and the like.

In addition, the specific value of the angle formed between the first flight direction and the second flight direction is not defined and can be set by those skilled in the art according to the type and the design requirements of the UAV. For example, the angle can be set as 90°, 180° or 270°. Of course, the angle can also be set as 70°, 80°, 110°, 130° or 150°, etc; in addition, the angle can be set before the flight of the UAV, and can also be set after the flight of the UAV, where, in some embodiments, the angle is set as a preset angle; thus, in the flight process of the UAV, the conditions whether the UAV has a vibration can be known in real time, so that an adjustment can be conducted on the UAV timely to avoid an impact on the flight effect of the UAV and even a case of a crash, thus the safety and reliability of flight of the UAV are improved.

### The Twenty-Fourth Embodiment

On the basis of the second embodiment, it can be seen by proceeding to refer to FIG. 10, in the case that the angle formed between the first flight direction and the second flight direction is set as 1800, the first flight direction and the second flight direction are opposite to each other; at this time, in order to make the technical solution better understood, the first flight direction is defined as a forward flight direction, and the second direction is defined as a reverse flight direction, thus, the first processing circuit 2 can also be configured to:

determine, within a preset period of time, switching times of the UAV between the forward flight direction and the reverse flight direction according to the flight data.

Where, the implementing process and the implementing effects of the functions implemented by the first processing circuit 2 above are the same as those of the S121 in the third embodiment above, and in particular, reference can be made to the content described above, to which unnecessary details will not be given here.

The switching times, which are determined according to the flight data, of the UAV between different directions, are defined specifically as the switching times of the UAV, which are determined according to the flight data, between the forward flight direction and the reverse flight direction of the UAV. Since the forward flight direction is opposite to the reverse one, the accuracy and reliability of the analysis of the flight data, thus the accuracy and reliability of the vibration detection of the UAV are improved, therefore it is possible to determine whether the UAV has a vibration in the forward and reverse flight directions accurately so as to conduct an adjustment on the UAV timely, and further improve the stability and reliability of the system.

### The Twenty-Fifth Embodiment

On the embodiment above, it can be seen by proceeding to refer to FIG. 10, the specific method, for determining in a preset period of time the switching times of the UAV between the forward and reverse flight directions according to the flight data, is not defined in the present solution, and can be set by those skilled in the art according to the specific design requirements, where, the determination of the switching times can be obtained by the first processing circuit 2 in a manner as follows:

the first processing circuit 2 is configured to:

conduct an FFT on the flight data in a preset period of time, and determine a frequency corresponding to the flight data;

determine the switching times according to the frequency.

Where, the implementing process and the implementing effects of the functions implemented by the first processing circuit 2 above are the same as those of the steps S1211-S1212 in the fourth embodiment above, and in particular, reference can be made to the content described above, to which unnecessary details will not be given here.

The flight data is processed by the first processing circuit 2 using the FFT, and then the frequency corresponding to information of speed, acceleration and angular speed, etc. is obtained. Moreover the switching times are determined by means of the frequency, and the conditions whether the UAV has a vibration can be obtained visually, quickly and accurately, which improves the obtaining efficiency and accuracy for the vibration detection and enables a quick determination of the vibration conditions of the UAV in the flight process, so as to make it possible for a timely adjustment of the UAV and further ensure the safety and reliability of the flight of the UAV.

### The Twenty-Sixth Embodiment

It can be seen with reference to FIG. 3, on the basis of the embodiment above, the flight data is processed using an FFT; although the above method can ensure the efficiency and accuracy of the processing of flight data, the consumption of the processor and the memory is large when the FFT is used to process the flight data, i.e., most of the resources of the processor and memory can be occupied, which will easily result in a case that the processor and memory are unable to handle the control of other devices timely; and at the moment when the UAV starts, if the flight data are processed by the method above, it is easy to result in a false detection, thus have an impact on the determination of the flight conditions of the UAV by the system; based on the above existing circumstances, the first processing circuit 2 is further configured to:

count a switching between the forward flight direction and the reverse flight direction into the switching times if, in the preset period of time, the speed of the UAV after the switching between the forward flight direction and the reverse flight direction is greater than or equal to a threshold speed in the direction.

Where, the implementing process and the implementing effects of the functions implemented by the first processing circuit 2 above are the same as those of the S1213 in the fifth embodiment above, and in particular, reference can be made to the content described above, to which unnecessary details will not be given here.

In the embodiment the analysis and processing are conducted on the speed directly by the first processing circuit 2 so as to reduce the consumptions of the processor and the memory of the UAV, and then improve the processing ability of the processor and memory of the UAV; moreover, the situation of false detection of the UAV at the moment of the start is avoided by employing the method; thus the practicability of the method, the accuracy and reliability of the adjustment and control of the UAV are improved.

### The Twenty-Seventh Embodiment

On the basis of the embodiment above, it can be seen by proceeding to refer to FIG. 10, in the processing of the speed after the switching between the forward flight direction and the reverse flight direction and the threshold speed of the direction, there are not only the case that the speed is greater than or equal to the threshold speed in the direction, but also other cases, therefore the first processing circuit 2 is further configured to:

still not count a switching between the forward flight direction and the reverse flight direction into the switching times if the speed of the UAV after the switching between the forward flight direction and the reverse flight direction is greater than or equal to the threshold speed in the direction.

Where, the implementing process and the implementing effects of the functions implemented by the first processing circuit 2 above are the same as those of the S1214 in the sixth embodiment above, and in particular, reference can be made to the content described above, to which unnecessary details will not be given here.

### The Twenty-Eighth Embodiment

On the basis of the twenty-seventh embodiment above, it can be seen by proceeding to refer to FIG. 10, the first processing circuit 2 is further configured to:

still not count the switching between the forward flight direction and the reverse flight direction into the switching times if the speed of the UAV after the switching between the forward flight direction and the reverse flight direction is greater than or equal to the threshold speed in the direction.

Where, the implementing process and the implementing effects of the functions implemented by the first processing circuit 2 above are the same as those of the S215 in the seventh embodiment above, and in particular, reference can be made to the content described above, to which unnecessary details will not be given here.

### The Twenty-Ninth Embodiment

on the basis of the embodiment above, it can be seen by proceeding to refer to FIG. 10, the specific method for determining whether the UAV has a vibration according to the switching times is not defined in the present embodiment and can be set by those skilled in the art according to the specific design requirements, where in some embodiments, the first determining circuit 3 can be configured specifically to:

determine that the UAV has a vibration if the switching times are greater than or equal to preset standard times; or

determine that the UAV has no vibration if the switching times are less than the preset standard times in the preset period of time.

Where, the implementing process and the implementing effects of the functions implemented by the first processing circuit 3 above are the same as those of the S131-S132 in the eighth embodiment above, and in particular, reference can be made to the content described above, to which unnecessary details will not be given here.

### The Thirtieth Embodiment

On the basis of the third embodiment above, it can be seen by proceeding to refer to FIG. 10, the forward flight directions and the reverse flight directions are not defined in the technical solution and can be set by those skilled in the art according to the specific design requirements:

For example, in one dimension, the forward flight direction is set as the forward direction of any coordinate axis of an X-axis, a Y-axis and a Z-axis in a three-dimensional space of the coordinate system which is composed of the X-axis, the Y-axis and the Z-axis; accordingly, the reverse flight direction is set as the reverse direction of any coordinate axis of the X-axis, the Y-axis and the Z-axis.

The setting method and the setting effects of the forward flight directions and the reverse flight directions in one dimension in the embodiment above are the same as those of the forward flight directions and the reverse flight directions in the ninth embodiment, and in particular, reference can be made to the content described above, to which unnecessary details will not be given here.

### The Thirty-First Embodiment

On the basis of the third embodiment above, it can be seen by proceeding to refer to FIG. 2, the forward flight directions and the reverse flight directions are not defined in the technical solution and can be set by those skilled in the art according to specific design requirements:

In two dimensions, the forward flight directions are set as a first direction of any two coordinate axes of an X-axis, a Y-axis and a Z-axis in a three-dimensional space of the coordinate system which is composed of the X-axis, the Y-axis and the Z-axis; accordingly, the reverse directions are set as a direction of any two coordinate axes of the X-axis, the Y-axis and the Z-axis, opposite to the first direction.

The setting method and the setting effects of the forward flight directions and the reverse flight directions in two dimensions in the embodiment above are the same as those of the forward flight directions and the reverse flight directions in the tenth embodiment, and in particular, reference can be made to the content described above, to which unnecessary details will not be given here.

### The Thirty-Second Embodiment

On the basis of the embodiment above, it can be seen by proceeding to refer to FIG. 10, the forward flight directions and the reverse flight directions are not defined in the technical solution and can be set by those skilled in the art according to the specific design requirements:

In three dimensions, the forward flight direction is set as the second direction of an X-axis, a Y-axis and a Z-axis in the three-dimensional space of the coordinate system which is composed of the X-axis, the Y-axis and the Z-axis; accordingly, the reverse flight direction is the direction opposite to the second direction of the X-axis, the Y-axis and the Z-axis.

The setting method and the setting effects of the forward flight directions and the reverse flight directions in the three-dimensional space in the embodiment above are the same as those of the forward flight directions and the reverse flight directions in the eleventh embodiment, and in particular, reference can be made to the content described above, to which unnecessary details will not be given here.

### The Thirty-Third Embodiment

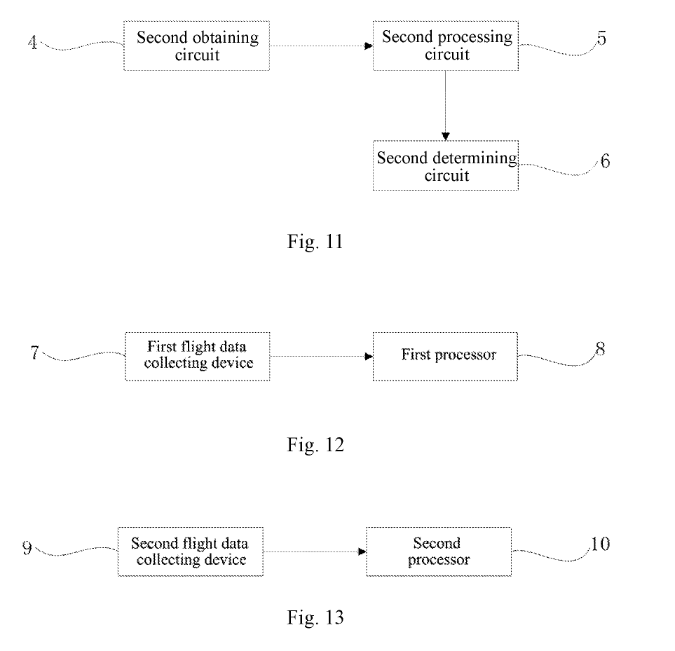

A tracking control system of the UAV is provided in the present embodiment. FIG. 11 is a schematic diagram of the system for tracking control of the UAV provided in the first embodiment of the present disclosure. It can be seen with reference to FIG. 1, the system for tracking control of the UAV includes:

a second obtaining circuit 4, configured to obtain flight data of the UAV;

a second processing circuit 5, configured to determine the switching times of the UAV between different flight directions in the preset period of time according to the flight data;

a second determining circuit 6, configured to determine whether the UAV has a vibration according to the switching times;

the second determining circuit 6, further configured to determine whether to continue tracking the target according to the vibration conditions of the UAV.

Where, the specific structures of the second obtaining circuit 4, the second processing circuit 5 and the second determining circuit 6 above are not defined and can be set by those skilled in the art arbitrarily according to the functions implemented by each circuit above; in addition, the implementing process and the implementing effects of the functions implemented by the second obtaining circuit 4, the second processing circuit 5 and the second determining circuit 6 are the same as those of the steps S21-S23 in the twelfth embodiment above, and in particular, reference can be made to the content described above, to which unnecessary details will not be given here.

In the system for vibration detection of the UAV provided in the present embodiment, the second obtaining circuit 2 obtains the flight data in the preset period of time, then the second processing circuit 5 determines the switching times of the UAV between different directions according to the flight data, and the second determining circuit 6 determines whether the UAV has a vibration according to the switching times, and next the conditions of the UAV can be adjusted timely before it is determined that the UAV has a large magnitude of vibration so as to avoid an impact on the normal operation and flight of the UAV and even a case of a crash, thus to ensure the safety and reliability of the flight of the UAV and improve the practicability of the system for vibration detection system of the UAV.

### The Thirty-Fourth Embodiment

On the basis of the embodiments above, it can be seen by proceeding to refer to FIG. 11, in order to make clearer the meaning of different flight directions in the step of determining the switching times of the UAV between different directions according to the flight data, the present embodiment sets the different flight directions to include: a first flight direction and a second flight direction, with an angle formed therebetween.

Where, the specific direction features of the first flight direction and the second direction can be set by those skilled in the art according to the specific design requirements, for example, they can be set as a combination of any two of east, west, south, north, southeast, northeast, west, southwest and northwest on the map; alternatively the first or the second flight direction can be set as any direction between any two adjacent directions of the eight directions above; for example, the first flight direction is set as 35° east by south, and the second flight direction is set as 70° west by north, and the like.

In addition, the specific value of the angle formed between the first flight direction and the second flight direction is not defined and can be set by those skilled in the art according to the type and the design requirements of the UAV. For example, the angle can be set as 90°, 180° or 270°. Of course, the angle can also be set as 70°, 80°, 110°, 130° or 150°, etc; in addition, the angle can be set before the flight of the UAV, and can also be set after the flight of the UAV, where, in some embodiments, the angle is set as a preset angle; thus, in the flight process of the UAV, the conditions whether the UAV has a vibration can be known in real time, so that an adjustment can be conducted on the UAV timely to avoid an impact on the flight effect of the UAV and even a case of a crash, thus the safety and reliability of flight of the UAV are improved.

### The Thirty-Fifth Embodiment

On the basis of the second embodiment, it can be seen by proceeding to refer to FIG. 11, in the case that the angle formed between the first flight direction and the second flight direction is set as 180°, the first flight direction and the second flight direction are opposite to each other; at this time, in order to make the technical solution better understood, the first flight direction is defined as a forward flight direction, and the second direction is defined as a reverse flight direction, thus, the second processing circuit 5 can also be configured to:

determine, within a preset period of time, switching times of the UAV between the forward flight direction and the reverse flight direction according to the flight data.

Where, the implementing process and the implementing effects of the functions implemented by the second processing circuit 5 above are the same as those of the S221 in the fourteenth embodiment above, and in particular, reference can be made to the content described above, to which unnecessary details will not be given here.

The second processing circuit 5 defines specifically the switching times, which are determined according to the flight data, of the UAV between different directions as the switching times of the UAV, which are determined according to the flight data between the forward flight direction and the reverse flight direction of the UAV. Since the forward flight direction is opposite to the reverse one, the accuracy and reliability of the analysis of the flight data, the accuracy and reliability of the vibration detection of the UAV are improved, therefore it is possible to determine whether the UAV has a vibration in the forward and reverse flight directions accurately so as to conduct an adjustment on the UAV timely, and further improve the stability and reliability of the system.

### The Thirty-Sixth Embodiment

On the embodiment above, it can be seen by proceeding to refer to FIG. 11, the specific method, for determining in a preset period of time the switching times of the UAV between the forward and reverse flight directions according to the flight data, is not defined in the present solution, and can be set by those skilled in the art according to the specific design requirements, where, the determination of the switching times can be obtained by the second processing circuit in a manner as follows:

the second processing circuit 5 is configured to:

conduct an FFT on the flight data in a preset period of time, and determine a frequency corresponding to the flight data;

determine the switching times according to the frequency.

Where, the implementing process and the implementing effects of the functions implemented by second processing circuit 5 above are the same as those of the steps S2211-S2212 in the fifteenth embodiment above, and in particular, reference can be made to the content described above, to which unnecessary details will not be given here.

The flight data is processed by the first processing circuit 2 using the FFT, and then the frequency corresponding to information of speed, acceleration and angular speed, etc. is obtained. Moreover the switching times are determined by means of the frequency, and the conditions whether the UAV has a vibration can be obtained visually, quickly and accurately, which improves the obtaining efficiency and accuracy for the vibration detection and enables a quick determination of the vibration conditions of the UAV in the flight process, so as to make it possible for a timely adjustment of the UAV and further ensure the safety and reliability of the flight of the UAV.

### The Thirty-Seventh Embodiment

It can be seen with reference to FIG. 11, on the basis of the embodiment above, the flight data is processed using an FFT; although the above method can ensure the efficiency and accuracy of the processing of flight data, the consumption of the processor and the memory is large when the FFT is used to process the flight data, i.e., most of the resources of the processor and memory can be occupied, which will easily result in a case that the processor and memory are unable to handle the control of other devices timely; and at the moment when the UAV starts, if the flight data are processed by the method above, it is easy to result in a false detection, thus have an impact on the determination of the flight conditions of the UAV by the system; based on the above existing circumstances, the second processing circuit 5 is further configured to:

count a switching between the forward flight direction and the reverse flight direction into the switching times if, in the preset period of time, the speed of the UAV after the switching between the forward flight direction and the reverse flight direction is greater than or equal to a threshold speed in the direction.

Where, the implementing process and the implementing effects of the functions implemented by the second processing circuit 5 above are the same as those of the S2213 in the sixteenth embodiment above, and in particular, reference can be made to the content described above, to which unnecessary details will not be given here.

In the embodiment the analysis and processing are conducted on the speed directly by the second processing circuit 5 so as to reduce the consumptions of the processor and the memory of the UAV, and then improve the processing ability of the processor and memory of the UAV; moreover, the situation of false detection of the UAV at the moment of the start is avoided by employing the method; thus the practicability of the method, the accuracy and reliability of the adjustment and control of the UAV are improved.

### The Thirty-Eighth Embodiment

On the basis of the embodiment above, it can be seen by proceeding to refer to FIG. 11, in the processing of the speed after the switching between the forward flight direction and the reverse flight direction and the threshold speed of the direction, there are not only the case that the speed is greater than or equal to the threshold speed in the direction, but also other cases, therefore the second processing circuit 5 is further configured to:

still not count a switching between the forward flight direction and the reverse flight direction into the switching times if the speed of the UAV after the switching between the forward flight direction and the reverse flight direction is greater than or equal to the threshold speed in the direction.

Where, the implementing process and the implementing effects of the functions implemented by the second processing circuit 5 above are the same as those of the S2214 in the seventeenth embodiment above, and in particular, reference can be made to the content described above, to which unnecessary details will not be given here.

### The Thirty-Nineteenth Embodiment

On the basis of the embodiment above, it can be seen by proceeding to refer to FIG. 11, the second processing circuit 5 is further configured to:

still not count a switching between the forward flight direction and the reverse flight direction into the switching times if the speed of the UAV after the switching between the forward flight direction and the reverse flight direction is greater than or equal to the threshold speed in the direction.

Where, the implementing process and the implementing effects of the functions implemented by the second processing circuit 5 above are the same as those of the S2215 in the eighteenth embodiment above, and in particular, reference can be made to the content described above, to which unnecessary details will not be given here.

### The Fortieth Embodiment

On the basis of the embodiment above, it can be seen by proceeding to refer to FIG. 11, the specific method for determining whether the UAV has a vibration according to the switching times is not defined in the present embodiment and can be set by those skilled in the art according to the specific design requirements, where in some embodiments, the second determining circuit 6 can be configured specifically to:

determine that the UAV has a vibration if the switching times are greater than or equal to preset standard times; or

determine that the UAV has no vibration if the switching times are less than the preset standard times in the preset period of time.

Where, the implementing process and the implementing effects of the functions implemented by the second determining circuit 6 above are the same as those of the S231-S232 in the nineteenth embodiment above, and in particular, reference can be made to the content described above, to which unnecessary details will not be given here.

The Forty-First Embodiment

On the basis of the embodiment above, it can be seen by proceeding to refer to FIG. 11, the control policy of determining whether to continue tracking the target according to the vibration conditions of the UAV is not defined in the technical solution, and can be set by those skilled in the art according to the specific design requirements, where in some embodiments, the second determining circuit 6 can be configured to:

determine to stop tracking the target if it is determined that the UAV has a vibration; or

determine to continue tracking the target if it is determined that the UAV has no vibration.

Where, the implementing process and the implementing effects of the functions implemented by the second determining circuit 6 above are the same as those of the S233-S234 in the twentieth embodiment above, and in particular, reference can be made to the content described above, to which unnecessary details will not be given here.

### The Forty-Second Embodiment

On the basis of the embodiment above, it can be seen by proceeding to refer to FIG. 11, the forward flight directions and the reverse flight directions are not defined in the technical solution and can be set by those skilled in the art according to the specific design requirements:

For example, in one dimension the forward flight direction is set as the forward direction of any coordinate axis of an X-axis, a Y-axis and a Z-axis in the three-dimensional space of the coordinate system which is composed of the X-axis, the Y-axis and the Z-axis; accordingly, the reverse flight direction is set as the reverse direction of any coordinate axis of the X-axis, the Y-axis and the Z-axis.

Where, the specific directions of the X-axis, the Y-axis and the Z-axis are not defined and can be set by those skilled in the art differently according to their own habits. For example, the X-axis can be set as the onward-to-backward direction of the horizontal, or set as the leftward-to-rightward direction of the horizontal, or set as the upward-to-downward direction of the vertical; usually, the X-axis refers to the onward-to-backward direction, the Y-axis refers to the leftward-to-rightward direction, and the Z-axis refers to the upward-to-downward direction; however, the forward direction of the axis can be set arbitrarily, for example, the onward, leftward and upward directions can be set as the forward directions, then the backward, rightward and downward directions accordingly are the reverse directions; alternatively the backward, rightward and downward directions can be set as the forward directions, then the onward, leftward and upward directions accordingly are reverse directions, as long as the forward flight directions and the reverse flight directions of the UAV can be determined clearly, to which unnecessary details will not be given here.

### The Forty-Third Embodiment

A UAV is provided in the embodiment. FIG. 12 is a schematic structural diagram of the UAV provided in the first embodiment of the present disclosure; by referring to the FIG. 12, it can be known that the UAV includes: a first flight data collecting device 7 and a first processor 8;

The first flight data collecting device 7 is configured to obtain the flight data of the UAV;

The first processor 8 is configured to perform:

determining, within a preset period of time, switching times of the UAV between different directions according to the flight data;

determining whether the UAV has a vibration according to the switching times.

Where, the specific structures of the first flight data collecting device 7 and the first processor 8 are not defined and can be set by those skilled in the art arbitrarily according to the functions realized by the respective devices, to which unnecessary details will not be given here; in addition, the implementing process and the implementing effects of the operating steps implemented by the first flight data collecting device 7 and the first processor 8 in the embodiment are the same as those of S11-S13 in the first embodiment above, and in particular, reference can be made to the content described above, to which unnecessary details will not be given here.

In addition, the first processor 8 in the embodiment can not only implement the above functions, be provided with the operating steps of the second embodiment to the eleventh embodiment, but also achieve the technical effects accordingly, and in particular, reference can be made to the content described above, to which unnecessary details will not be given here.

In the UAV provided in the present embodiment, the flight data is obtained by the first flight data collecting device 7 in the preset period of time, then the switching times of the UAV between different directions is determined by the first processor 8 according to the flight data, then whether the UAV has a vibration is determined according to the switching times, and next the conditions of the UAV can be adjusted timely before it is determined that the UAV has a large magnitude of vibration so as to avoid an impact on the normal operation and flight of the UAV and even a case of a crash, thus to improve the safety and reliability of the flight of the UAV.

### The Forty-Fourth Embodiment

In the fifth aspect of the present disclosure there is provided a storage medium on which program code is stored. When the program code is run, the method for vibration detection will be performed, the method specifically including:

obtaining flight data of the UAV;

determining, within a preset period of time, switching times of the UAV between different flight directions according to the flight data;

determining whether the UAV has a vibration according to the switching times.

Where, the specific form and the specific structure of the storage medium are not defined and can be set by those skilled in the art according to the specific design requirements, as long as the above function and effects are achieved, to which unnecessary details will not be given here; in addition, the operating process and the implementing effects of the methods implemented by the program code stored in the storage medium are the same as those of S11-S13 in the first embodiment, and in particular, reference can be made to the content described above, to which unnecessary details will not be given here.

In addition, the storage medium in the embodiment can not only implement the program code of the above method steps, but also store the program code of the operating steps in the second embodiment to the eleventh embodiment, and after the program code above is run, corresponding technical effects can be achieved. In particular, reference can be made to the content described above, to which unnecessary details will not be given here.

By running the program code stored in the storage medium provided in the present embodiment stores, the flight data can be obtained in the preset period of time. Then the switching times of the UAV between different directions are determined by the first processor 8 according to the flight data, then whether the UAV has a vibration is determined according to the switching times, and next the conditions of the UAV can be adjusted timely before it is determined that the UAV has a large magnitude of vibration so as to avoid an impact on the normal operation and flight of the UAV and even a case of a crash, thus to improve the safety, reliability, and practicability of the flight of the UAV.

### The Forty-Fifth Embodiment

A UAV is provided in the embodiment. FIG. 13 is a structural diagram of the UAV provided in the second embodiment of the present disclosure; By referring to the FIG. 13, it can be known that, the UAV includes: a second flight data collecting device 9 and a second processor 10;

The second flight data collecting device 9 is configured to obtain the flight data of the UAV;

The second processor 10 is configured to perform:

determining, within a preset period of time, switching times of the UAV between different directions according to the flight data;

determining whether the UAV has a vibration according to the switching times;

determining whether to continue tracking the target according to the vibration conditions.

Where, the specific forms and the specific structures of the second flight data collecting device 9 and the second processor 10 are not defined and can be set by those skilled in the art according to the specific design requirements, as long as the above function and effects are achieved, to which unnecessary details will not be given here; in addition, the operating process and the implementing effects of the methods implemented by the second flight data collecting device 9 and the second processor 10 are the same as those of S21-S24 in the twelfth embodiment, and in particular, reference can be made to the content described above, to which unnecessary details will not be given here.

In addition, the second processor 10 in the embodiment can not only implement the above functions, be provided with the operating steps of the above thirteenth embodiment to twenty-first embodiment, but also achieve the corresponding technical effects. In particular, reference can be made to the content described above, to which unnecessary details will not be given here.

In the UAV provided in the present embodiment, the flight data can be obtained in the preset period of time by the second flight data collecting device 9; the switching times of the UAV between different directions are determined by the second processor 10 according to the flight data; then whether the UAV has a vibration is determined according to the switching times; and next the conditions of the UAV can be adjusted timely before it is determined that the UAV has a large magnitude of vibration so as to avoid an impact on the normal operation and flight of the UAV and even a case of a crash, thus to improve the safety and reliability of the flight of the UAV.

### The Forty-Sixth Embodiment

In the present embodiment there is provided another storage medium on which program code is stored. When the program code is run, the method for tracking control of the UAV will be performed, the method specifically including:

obtaining flight data of the UAV;

determining, within a preset period of time, switching times of the UAV between different flight directions according to the flight data;

determining whether the UAV has a vibration according to the switching times;

determining whether to continue tracking the target according to the vibration conditions.

Where, the specific form and the specific structure of the storage medium are not defined and can be set by those skilled in the art according to the specific design requirements, as long as the above function and effects are achieved, to which unnecessary details will not be given here; in addition, the operating process and the implementing effects of the methods implemented by the program code stored in the storage medium are the same as those of S21-S24 in the twelfth embodiment, and in particular, reference can be made to the content described above, to which unnecessary details will not be given here.

In addition, the storage medium in the embodiment can not only implement the program code of the above method steps, but also store the program code of the operating steps in the thirteen embodiment to the twenty-first embodiment, and after the program code above is run, corresponding technical effects can be achieved. In particular, reference can be made to the content described above, to which unnecessary details will not be given here.

By running the program code stored in the storage medium provided in the present embodiment stores, the flight data can be obtained in the preset period of time. Then the switching times of the UAV between different directions are determined by the first processor 8 according to the flight data, then whether the UAV has a vibration is determined according to the switching times, and next the conditions of the UAV can be adjusted timely before it is determined that the UAV has a large magnitude of vibration so as to avoid an impact on the normal operation and flight of the UAV and even a case of a crash, thus to improve the safety, reliability, and practicability of the flight of the UAV.

In the several embodiments provided in the present disclosure, it should be understood that the related devices and methods disclosed can be implemented in other ways. For example, the device embodiments described above are merely illustrative, e.g., the classification of the circuits or the units is only a classification with respect to logical function, and there could be other forms of classification in practical implementation. For example, a plurality of units or components can be combined or integrated into another system, alternatively some features can be ignored or not performed. For another, the mutual coupling or direct coupling or a communication connection shown or discussed can be indirect coupling or a communication connection via some interfaces, devices or units, and can be electrical, mechanical or in other forms.

The units illustrated as separate components can be or cannot be separated physically, and the components shown as units can be or cannot be physical units, i.e. they can be located in one place, or can be distributed on a plurality of network units. Some or all units can be selected to achieve the purpose of the solution of the embodiment according to the actual needs.

In addition, each functional unit in each embodiment of the present disclosure can be integrated in one processing unit, alternatively the case can be the physical existence of each separated unit, or two or more units integrated in one unit. The integrated units above can be implemented in the form of either hardware or software functional units.

The integrated unit can be stored in a computer readable storage medium if they are implemented in the form of software functional units and sold or used as an independent product. Based on such understanding, the essence of the technical solution of the present disclosure, the part that contributes to the prior art, or all or part the technical solution can be embodied in the form of software products. The computer software product, which is stored in a storage medium, includes a number of instructions so that the computer processor executes all or part of the steps of each embodiment of the present disclosure. However, the aforementioned storage medium includes: a USB flash disk, a mobile hard disk, a read-only memory (ROM), a random access memory (RAM), a disk, a CD, etc. in which the program code can be stored.

The embodiments described above are only the embodiments of the present disclosure, and do not limit the scope of the patent of the present disclosure. An equivalent structure or an equivalent process alternate made by using the description and drawing contents of the present disclosure, or those made directly or indirectly using the technical solutions in other related technical fields are similarly included in the scope of the present disclosure.

Finally, it should be noted that each of the above embodiments is only used for illustrating the technical solutions of embodiments of the present disclosure, rather than limiting them; although the embodiments of the present disclosure are illustrated in detail with reference to each of the aforementioned embodiments, those ordinary skilled in the art should understand: the technical solutions recorded in each of the aforementioned embodiments can still be amended, or part or all of the technical features can be substituted comparably; however, these modifications or substitutions do not make the essence of the corresponding technical solutions depart from the scope of the embodiment solutions of the present disclosure.

What is claimed is:

1. A method for tracking control of an unmanned aerial vehicle (UAV), comprising:
obtaining flight data of the UAV;
determining, within a preset period of time and according to the flight data, a number of switching times of the UAV switching between different flight directions;
determining whether the UAV is vibrating according to the number of switching times; and
determining whether to continue tracking a target according to whether the UAV is vibrating.

2. The method according to claim 1, wherein the different flight directions include a first flight direction and a second flight direction, an angle being formed between the first flight direction and the second flight direction.

3. The method according to claim 1, wherein determining, within the preset period of time and according to the flight data, the number of switching times of the UAV switching between the different flight directions includes:
determining, within the preset period of time and according to the flight data, a number of switching times of the UAV switching between a forward flight direction and a reverse flight direction.

4. The method according to claim 3, wherein determining, within the preset period of time and according to the flight data, the number of switching times of the UAV switching between the forward flight direction and the reverse flight direction includes:
conducting a fast Fourier transform (FFT) on the flight data within the preset period of time to determine a frequency corresponding to the flight data; and
determining the number of switching times of the UAV switching between the forward flight direction and the reverse flight direction according to the frequency.

5. The method according to claim 3, wherein determining, within the preset period of time according to the flight data, the number of switching times of the UAV switching between the forward flight direction and the reverse flight direction includes:
counting a switching between the forward flight direction and the reverse flight direction within the preset period of time into the number of switching times, in response to a speed of the UAV after switching from the forward flight direction to the reverse flight direction being greater than or equal to a threshold speed in the reverse flight direction or a speed of the UAV after switching from the reverse flight direction to the forward flight direction being greater than or equal to a threshold speed in the forward flight direction.

6. The method according to claim 3, wherein determining, within the preset period of time according to the flight data, the number of switching times of the UAV switching between the forward flight direction and the reverse flight direction includes:
not counting a switching between the forward flight direction and the reverse flight direction within the preset period of time into the number of switching times, in response to a speed of the UAV after switching from the forward flight direction to the reverse flight direction being less than a threshold speed in the reverse direction or a speed of the UAV after switching from the reverse flight direction to the forward flight direction being less than a threshold speed in the forward flight direction.

7. The method according to claim 6, wherein determining, within the preset period of time according to the flight data, the number of switching times of the UAV switching between the forward flight direction and the reverse flight direction further includes, after the switching between the forward flight direction and the reverse flight direction not being counted into the number of switching times:
not counting a subsequent switching between the forward flight direction and the reverse flight direction into the number of switching times, in response to a speed of the UAV after switching back from the reverse flight direction to the forward flight direction being more than or equal to the threshold speed in the forward flight direction or a speed of the UAV after switching back from the forward flight direction to the reverse flight direction being more than or equal to the threshold speed in the reverse flight direction.

8. The method according to claim 3, wherein:
the UAV is within a three-dimensional space of a coordinate system including an X-axis, a Y-axis, and a Z-axis; and
the forward flight direction is a forward direction of the X-axis and the reverse flight direction is a reverse direction of the X-axis.

9. The method according to claim 1, wherein determining whether the UAV is vibrating according to the number of switching times includes:
determining that the UAV is vibrating in response to the number of switching times within the preset period of time being greater than or equal to a preset standard number of times; or
determining that the UAV is not vibrating in response to the number of switching times being less than the preset standard number of times.

10. The method according to claim 9, wherein determining whether to continue tracking the target according to whether the UAV is vibrating includes:
determining to stop tracking the target in response to the UAV being vibrating; or
determining to continue tracking the target in response to the UAV not being vibrating.

11. An unmanned aerial vehicle (UAV) comprising:
a flight data collecting device configured to obtain flight data of the UAV; and
a processor configured to:
obtain flight data of the UAV;
determine, within a preset period of time and according to the flight data, a number of switching times of the UAV switching between different flight directions;
determine whether the UAV is vibrating according to the number of switching times; and
determine whether to continue tracking a target according to whether the UAV is vibrating.

12. The UAV according to claim 11, wherein the different flight directions include a first flight direction and a second flight direction, an angle being formed between the first flight direction and the second flight direction.

13. The UAV according to claim 11, wherein the processor is further configured to:
determine, within the preset period of time and according to the flight data, a number of switching times of the UAV switching between a forward flight direction and a reverse flight direction.

14. The UAV according to claim 13, wherein the processor is further configured to:
conduct a fast Fourier transform (FFT) on the flight data within the preset period of time to determine a frequency corresponding to the flight data; and
determine the number of switching times of the UAV switching between the forward flight direction and the reverse flight direction according to the frequency.

15. The UAV according to claim 13, wherein the processor is further configured to:
count a switching between the forward flight direction and the reverse flight direction within the preset period of time into the number of switching times, in response to a speed of the UAV after switching from the forward flight direction to the reverse flight direction being greater than or equal to a threshold speed in the reverse flight direction or a speed of the UAV after switching from the reverse flight direction to the forward flight direction being greater than or equal to a threshold speed in the forward flight direction.

16. The UAV according to claim 13, wherein the processor is further configured to:
not count a switching between the forward flight direction and the reverse flight direction within the preset period of time into the number of switching times, in response to a speed of the UAV after switching from the forward flight direction to the reverse flight direction being less than a threshold speed in the reverse direction or a speed of the UAV after switching from the reverse flight direction to the forward flight direction being less than a threshold speed in the forward flight direction.

17. The UAV according to claim 16, wherein the processor is further configured to, after not counting the switching between the forward flight direction and the reverse flight direction counted into the number of switching times:
not count a subsequent switching between the forward flight direction and the reverse flight direction into the number of switching times, in response to a speed of the UAV after switching back from the reverse flight direction to the forward flight direction being more than or equal to the threshold speed in the forward flight direction or a speed of the UAV after switching back from the forward flight direction to the reverse flight direction being more than or equal to the threshold speed in the reverse flight direction.

18. The UAV according to claim 13, wherein:
the UAV is within a three-dimensional space of a coordinate system including an X-axis, a Y-axis, and a Z-axis; and
the forward flight direction is a forward direction of the X-axis and the reverse flight direction is a reverse direction of the X-axis.

19. The UAV according to claim 11, wherein the processor is further configured to:
determine that the UAV is vibrating in response to the number of switching times within the preset period of time being greater than or equal to a preset standard number of times; or
determine that the UAV is not vibrating in response to the number of switching times being less than the preset standard number of times.

20. The UAV according to claim 19, wherein the processor is further configured to:
determine to stop tracking the target in response to the UAV being vibrating; or
determine to continue tracking the target in response to the UAV not being vibrating.
